(19) United States
(12) Patent Application Publication
(10) Pub. No.: US 2006/0259980 A1
(43) Pub. Date: Nov. 16, 2006

(54) Method and system for limiting rights of services

(75) Inventors: Scott A. Field, Redmond, WA (US); Chittur Sabbaraman, Carnation, WA (US); Ramesh Chinta, Sammamish, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/131,431

(22) Filed: May 16, 2005

(51) Int. Cl. H04L 9/32; H04L 9/00; G06K 9/00; G06F 15/16; G06F 17/30; G06F 7/04; G06F 7/58; H03M 1/68; G06K 19/00; H04K 1/00; H04N 7/16

(52) U.S. Cl. 726/27; 713/181; 713/165; 726/5; 726/9

(57) ABSTRACT

A method and system for controlling access rights and privileges of services is provided. A service control system creates a security identifier that is unique for each service that executes within a service host and adds the security identifiers to the security context of the service host. The service control system may create a unique security identifier for each service that is independent of the computer system and the account on which the service executes. The service control system may also adjust the privileges of the security context of a service host to be an aggregate of the privileges needed by the services that are to execute within the service host. The service control system may also create a restricted security context for the service host that includes the security identifiers of the services as restricted service identifiers.

### TECHNICAL FIELD

The described technology relates generally to executing services within a service host and particularly to limiting rights of the services.

### BACKGROUND

Operating systems typically provide services to various system programs, application programs, external programs, and so on. These services may need to execute as a process or a thread within a process to perform various services for these programs. For example, a file share service executing on one computer system may receive file access requests from other computer systems. The file share service may be responsible for authenticating and servicing the request. During the process of initialization, an operating system may identify from a configuration file the services that need to execute and then start the execution of those services.

The Windows operating system provides such services. Windows provides multiple service hosts in which the services may execute. The service hosts include a system service host, a network service host, and a local service host. Each of the service hosts executes in a separate account. A service control manager of the operating system is responsible for logging on to a system service account, network service account, and local service account and launching a service host to execute under that account. The system service host executes in the system service account, the network service host executes in the network service account, and so on. The use of multiple service hosts allows services to execute with varying levels of privileges and access rights that are appropriate for the service. For example, a service that requires a high privilege may execute in the system service host, while a service that requires a low privilege may execute in the local service host. The providers of services may set up the various service accounts to have the appropriate privileges and access rights and provide service configuration information that specifies which services should execute within which service hosts. For example, the configuration information may indicate that a file sharing service executes within the network service host and that a printing service executes within a local service host. The services that execute within a service host share the same security context and thus have the same privileges and access rights. In Windows operating system terminology, the services of a service host share the access token (i.e., the security context) including account and group security identifiers associated with the service account in which the service host executes.

Because service providers may not know or understand the privileges and access rights needed by a service or to simplify maintenance by a system administrator (as described below), the service providers may opt to execute each service in a service host that has the highest possible privilege and access rights. This execution of the services with privileges and access rights higher than those that are needed for correct operation of the service has presented problems. For example, many viruses have been installed on computer systems by exploiting vulnerabilities within the services that execute with privileges and access rights that are higher than needed. When a service executes with a higher than needed privilege or access right, the vulnerability may be exploited in such a way that malicious code causes significant damage because of its high privilege and access rights.

One way to reduce the risk that such a vulnerability is exploited is for a service provider to configure services in a special low privilege user account. However, a system administrator may find it difficult to maintain the configuration information for the services, the access control lists for objects accessed by the services, and the service accounts for all the computer systems of an enterprise. The system administrator may need to customize for each computer system the access control lists and service accounts. For example, each service account may have a password that needs to be changed periodically to implement a security policy of an enterprise. The system administrator would need to keep track of when the password of each service account of each computer system needs to be changed and change the passwords so that processing of the computer system is not disrupted.

It would be desirable to have techniques for managing services that would improve security and would simplify management of the services by a system administrator.

### SUMMARY

A method and system for controlling access rights and privileges of services is provided. A service control system creates a security identifier that is unique for each service that executes within a service host and adds the security identifiers to the security context of the service host. When a service host, or service executing within the service host, accesses an object, the security identifiers of the access token are used to identify access rights of the service host to the object. The service control system may create a unique security identifier for each service that is independent of the computer system and the account on which the service executes. The service control system may also adjust the privileges of the security context of a service host to be an aggregate of the privileges needed by the services that are to execute within the service host. The service control system may also create a restricted security context for the service host that includes the security identifiers of the services as restricted service identifiers.

### BRIEF DESCRIPTION OF THE DRAWINGS

FIG. 1 is a block diagram that illustrates components of the service control system in one embodiment.

FIG. 2 is a block diagram that illustrates a restricted access token of a service host and a security descriptor of an object that is accessible by a service of the service host.

FIG. 3 is a flow diagram that illustrates the processing of the service control manager of the service control system in one embodiment.

FIG. 4 is a flow diagram that illustrates the processing of the create service security identifier component in one embodiment.

FIG. 5 is a flow diagram that illustrates the processing of the adjust host privilege component of the service control system in one embodiment.

FIG. 6 is a flow diagram that illustrates the processing of a check access component in one embodiment.

FIG. 7 is a flow diagram that illustrates the processing of a create restricted token component in one embodiment.

### DETAILED DESCRIPTION

A method and system for controlling access rights and privileges of services is provided. In one embodiment, a service control system creates a security identifier that is unique for each service that executes within a service host and adds the security identifiers to the security context of the service host. The security context, such as an access token, includes the security identifiers and privileges of the service host. The security identifiers specify the access rights of the service host to various objects. When a service host, or service executing within the service host, accesses an object, the security identifiers of the access token are used to identify access rights of the service host to the object. For example, the object may have an associated access control list, within a security descriptor associated with the object, that maps security identifiers to their associated access rights. The privileges of an access token indicate rights of the service host to access the system-related capabilities. For example, a privilege may be the right of the service host to create accounts or to perform certain I/O operations. The service control system creates a unique security identifier for each service that may be independent of the computer system and the account on which the service executes. The service control system may apply a one-way hash function, such as the Secure Hash Algorithm, to the name of a service and may include the hash value as part of the security identifier for the service. Because the security identifiers of the services are unique and independent of the computer system and account, access control lists for objects can also be independent of the computer system and account. In one embodiment, the security identifiers are dependent only on the name of a service. As a result, the same access control lists can be distributed to all computer systems of an organization to implement a service-related security policy of the organization. In addition, because the security identifiers are independent of the account in which a service host executes, a service can be moved from one service host to another service host without having to modify the access control list of the objects that the service needs to access.

In one embodiment, the service control system adjusts the privileges of the access token of a service host to be an aggregate of the privileges needed by the services that are to execute within the service host. The service control system may include a service configuration store that identifies the privileges needed by each service. When a process is first created, the access token may include privileges that are not needed by any of the services that are to execute within the service host. To limit the privileges of the service host, the service control system identifies from the service configuration store the privileges that are needed by each service that will execute within the service host. The service control system then creates an aggregation of the privileges that are needed by the services. For example, the service control system may take the union of the needed privileges. The service control system then adjusts the privileges of the access token to that of the aggregation and removes unnecessary privileges. In this way, the service control system can limit the privileges of the access token of a service host to only those privileges that are actually needed by the services that will execute within the service host.

In one embodiment, the service control system creates a restricted access token for the service host. A restricted access token limits access of the service host to only those objects with access control lists that explicitly include security identifiers that are listed as restricted within the access token. For example, a system registry may have an access control list with an “everyone” security identifier that indicates that any security entity with a security identifier is allowed to access the system registry. A system administrator, however, may want to prevent services from accessing objects (e.g., system registry) to which they are not explicitly granted access in case the service includes or is infected with malicious code. To prevent such access, the service control system creates a restricted access token for a service host that indicates the service identifier of each service is restricted. When a service then attempts to access the system registry, the access will be denied because the access token is restricted and the restricted service identifiers are not in the access control list of the system registry. To allow a service with a restricted access token to access an object, the service provider can add the service identifier of the service to the access control list of the object. In this way, the service control system can restrict access of the services of a service host to only those objects that are explicitly designated as accessible to one of the services of the service host.

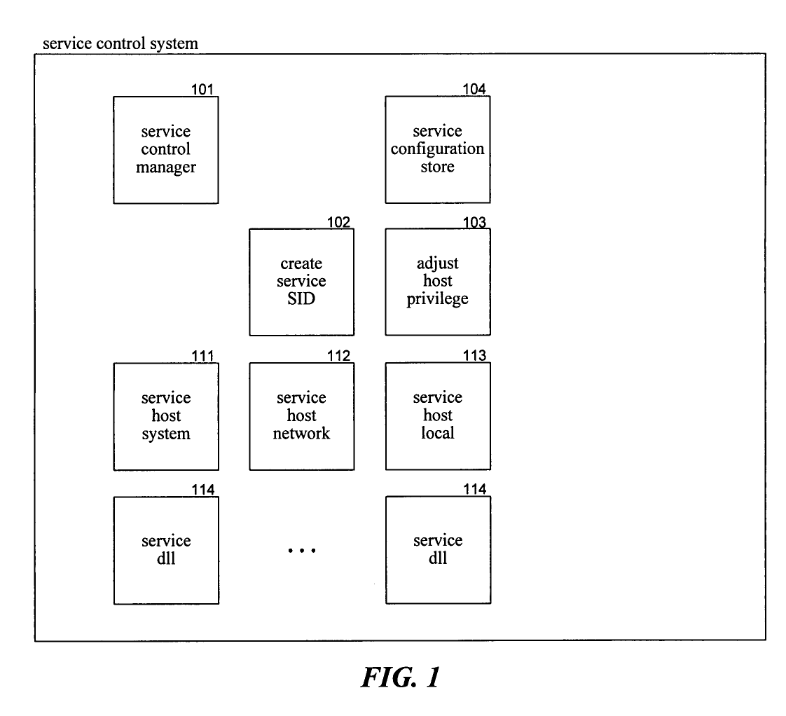

FIG. 1 is a block diagram that illustrates components of the service control system in one embodiment. The service control system includes a service control manager 101, a create service security identifier component 102, an adjust host privilege component 103, and a service configuration store 104. When the operating system initializes, it invokes the service control manager to start execution of services within service hosts as specified by the service configuration store. The service control manager invokes the create service security identifier component for each of the services to create a security identifier for that service. After the security identifiers are created, the service control manager logs on to the account for a service host passing the service security identifiers as supplemental group security identifiers. As part of the logon process, the operating system creates an access token for the account that includes the account security identifier along with the passed service security identifiers. In one embodiment, the service control manager may request that the access token be restricted. The service control manager may invoke the adjust host privilege component to adjust the privileges of the access token for a service host. The adjust host privilege component accesses the service configuration store to identify the privileges needed by each service. The adjust host privilege component then determines the aggregation of privileges that are needed by the services and then adjusts the privilege of the access token accordingly. The service control manager then creates a service host, such as service host 111, 112, or 113, to execute the services, such as service dynamic link libraries (“DLL”) 114. Alternatively, the service configuration information may be stored in the program image of a service, rather than a service configuration store. This would allow for the configuration information to be digitally protected along with the service program.

The computing device on which the service control system is implemented may include a central processing unit, memory, input devices (e.g., keyboard and pointing devices), output devices (e.g., display devices), and storage devices (e.g., disk drives). The memory and storage devices are computer-readable media that may contain instructions that implement the service control system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the service control system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The service control system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

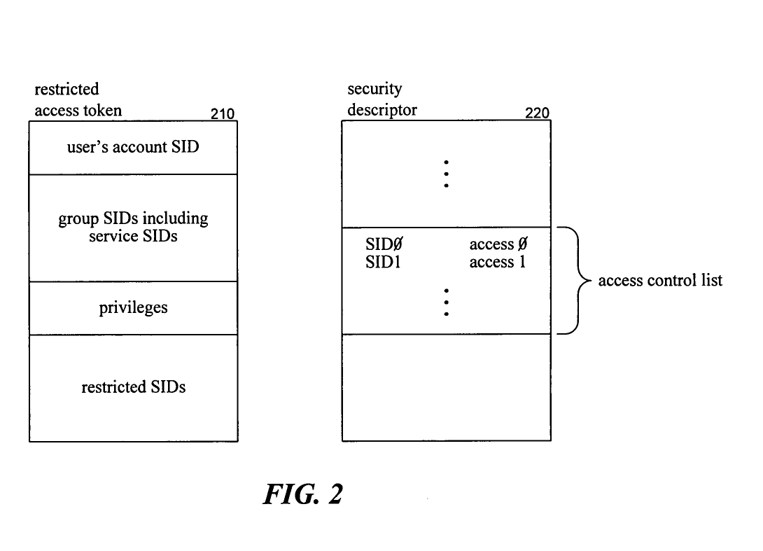

FIG. 2 is a block diagram that illustrates a restricted access token of a service host and a security descriptor of an object that is accessible by a service of the service host. The restricted access token 210 includes an account security identifier, group security identifiers that include the service security identifiers, privileges, and restricted security identifiers that include the service security identifiers. The security descriptor 220 includes an access control list that explicitly lists each security identifier and its access rights to the object associated with the security descriptor. A system administrator who wants to permit a service to access an object adds the security identifier of the service to the access control list of the security descriptor of the object. When the service attempts to access that object, the access is granted when a restricted security identifier of the restricted access token of the service is explicitly in the security descriptor. When the service attempts to access an object whose security descriptor does not explicitly include a security service identifier of the restricted access token, that access is denied. In this way, access of a service can be limited to only those objects to which a service of the service host has been given explicit access.

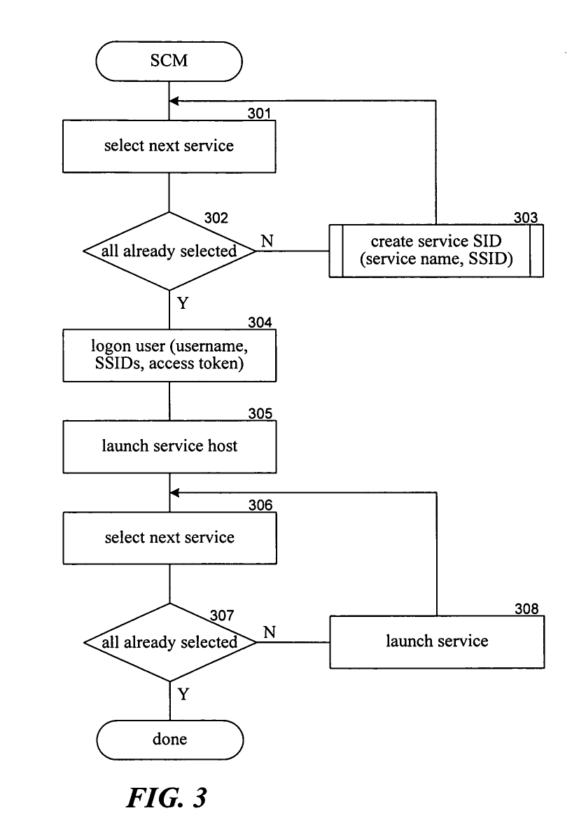

FIG. 3 is a flow diagram that illustrates the processing of the service control manager of the service control system in one embodiment. The service control manager, which is part of the operating system, is invoked to launch the services of a service host. The service control manager creates the service security identifiers for the services, ensures that an access token is created that includes those service security identifiers, creates the service host, and launches the services within the service host. In blocks 301-303, the service control manager loops creating the service security identifiers. In block 301, the manager selects the next service that is to be included in the service host as indicated by the service configuration store. In decision block 302, if all the services have already been selected, then the manager continues at block 304, else the manager continues at block 303. In block 303, the manager invokes the create service security identifier passing the name of the service and receiving the service security identifier in return. The manager then loops to block 301 to select the next service. In block 304, the manager invokes a function to log on as a service account as indicated by the service configuration store. The manager passes the create service security identifiers as supplemental security identifiers and receives the access token in return. In block 305, the manager starts the execution of the service host. In blocks 306-308, the manager (or the service host) loops launching each service within the service host. In block 306, the manager selects the next service. In decision block 307, if all the services have already been selected, then the manager completes, else the manager continues at block 308. In block 308, the manager launches the selected service and then loops to block 306 to select the next service.

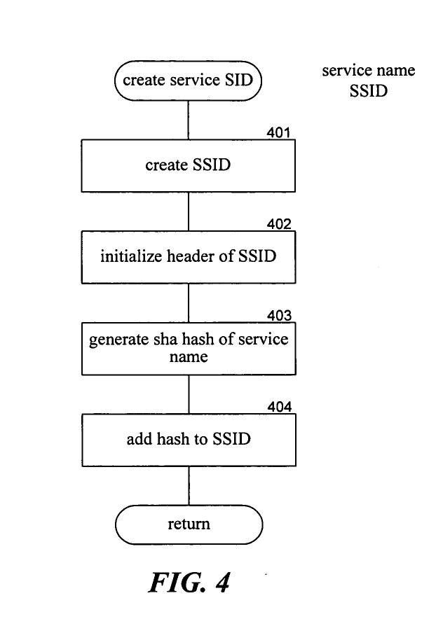

FIG. 4 is a flow diagram that illustrates the processing of the create service security identifier component in one embodiment. The component is passed a service name and returns a service security identifier. In block 401, the component creates a service security identifier. In block 402, the component initializes the header of the service security identifier to indicate that is a security service identifier. In block 403, the component applies the secured hash algorithm to the security name to generate a hash value. In block 404, the component adds the hash value to the service security identifier and then returns the service security identifier.

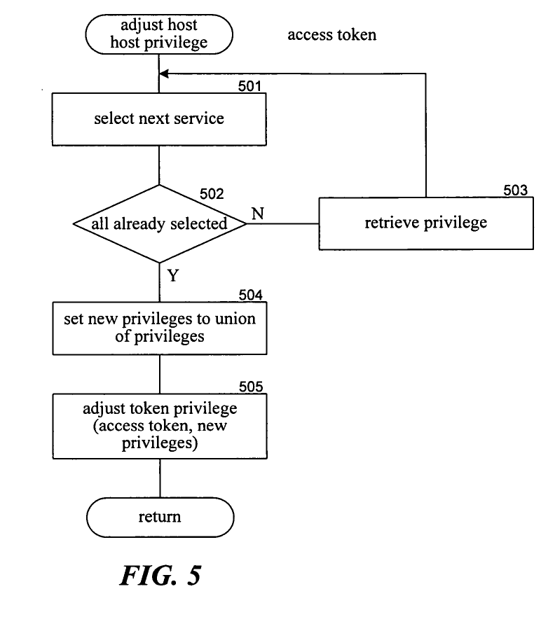

FIG. 5 is a flow diagram that illustrates the processing of the adjust host privilege component of the service control system in one embodiment. The component is passed an access token and returns an access token with the privileges modified. In blocks 501-503, the component loops retrieving the privileges of the services. In block 501, the component selects the next service that is to be launched within the service host as indicated by the service configuration store. In decision block 502, if all the services have already been selected, then the component continues at block 504, else the component continues at block 503. In block 503, the component retrieves the privileges for the selected service and then loops to block 501 to select the next service. If the privileges of a service are not indicated in the service configuration store, then the component may assign default privileges for the selected service. In block 504, the component determines the new privileges as the union of the retrieved privileges. In block 505, the component invokes an adjust token privilege function passing the access token and the new privileges to adjust the privileges of the access token. The component then returns.

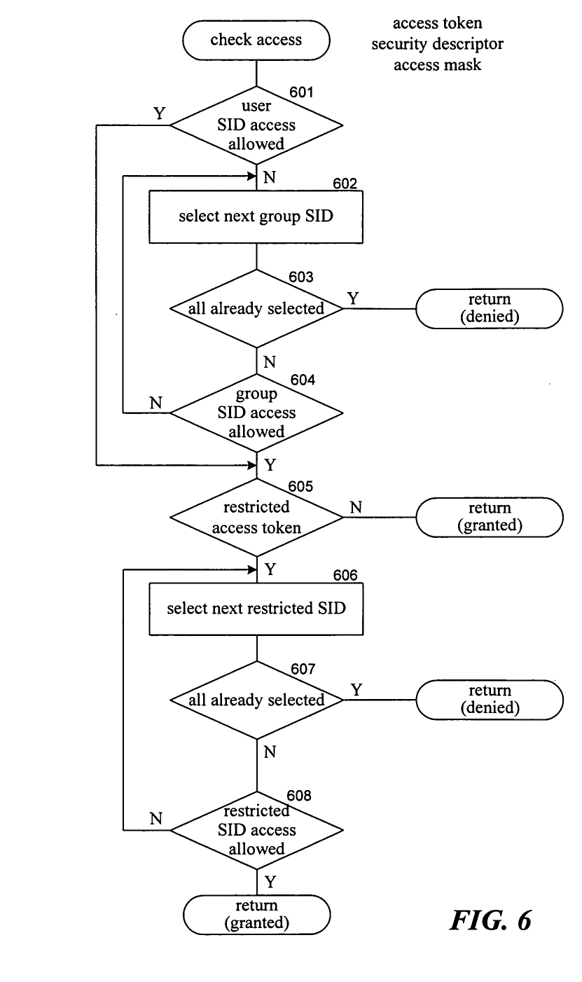

FIG. 6 is a flow diagram that illustrates the processing of a check access component in one embodiment. The check access component is passed an access token, a security descriptor, and an access mask. The component determines whether the entity presenting the access token has the access rights as indicated by the access mask to an object having the security descriptor. In decision block 601, if the account security identifier of the access token indicates access to the object can be granted, then the component continues at block 605, else the component continues at block 602. In blocks 602-404, the component loops determining whether each group security identifier indicates access can be granted to the object. In block 602, the component selects the next group security identifier of the access token. In decision block 603, if all the security identifiers have already been selected, then the component returns an indication that access is denied, else the component continues at block 604. In decision block 604, if the selected group security identifier indicates access to the object can be granted, then the component continues at block 605, else the component loops to block 602 to select the next group security identifier. The component continues at block 605 when the security identifier indicates that non-restricted access can be granted to determine whether restricted access can be granted. In decision block 605, if the access token is restricted, the component continues at block 606, else the component returns an indication that access to the object is granted. In blocks 606-608, the component loops determining whether the access control list of the security descriptor includes a restricted security identifier of the access token. In block 606, the component selects the next restricted security identifier. In decision block 607, if all the restricted security identifiers have already been selected, then the component returns an indication that access is denied, else the component continues at block 608. In decision block 608, if the restricted security identifier indicates that access to the object can be granted, then the component returns an indication that access is granted, else the component loops to block 606 to select the next restricted security identifier.

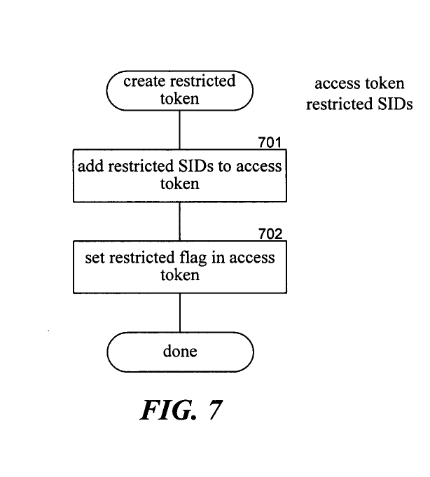

FIG. 7 is a flow diagram that illustrates the processing of a create restricted token component in one embodiment. The create restricted token component is passed an access token and restricted security identifiers. The component adds the restricted security identifiers to the access token. The processing of this component may be performed by a component that creates the access token when logging onto an account. In block 701, the component adds the restricted security identifiers to the access token. In block 702, the component sets a restricted flag in the access token to indicate that the access token is restricted and then completes.

From the foregoing, it will be appreciated that specific embodiments of the service control system have been described herein for purposes of illustration, but that various modifications may be made without deviating from the spirit and scope of the invention. Accordingly, the invention is not limited except as by the appended claims.

I/We claim:

1. A method in a computer system for identifying access rights of services, the method comprising:
for services that are to execute within a service host,
creating a security identifier that is unique to the service and independent of the computer system; and
adding the security identifier to a security context for the service host; and
when a service accesses an object, providing the security context with the added security identifiers to establish a right of the service to access the object.

2. The method of claim 1 wherein the security context is an access token.

3. The method of claim 1 wherein the creating of the security identifier includes generating a hash value based on a unique service name of the service.

4. The method of claim 3 wherein the hash value is generated using a secure hash algorithm.

5. The method of claim 1 wherein each computer system that executes the same service generates the same security identifier for the service.

6. The method of claim 1 wherein access control lists of objects include the security identifiers of services with access rights to the objects.

7. The method of claim 6 wherein the access control lists with the same security identifiers are distributed to multiple computer systems.

8. The method of claim 1 wherein the creating and adding of a security identifier is performed by a service control manager.

9. The method of claim 1 wherein the security context has privileges and including determining privileges needed by the services that are to execute within the service host and adjusting the privileges of the security context to an aggregation of the privileges needed by the services.

10. A method in a computer system for establishing privileges of services of a service host, the method comprising:
receiving a security context for the service host that includes privileges of the service host;
determining the privileges of the services of the service host; and
adjusting the privileges of the security context to an aggregation of the determined privileges.

11. The method of claim 10 wherein the receiving, determining, and adjusting are performed by a service control manager.

12. The method of claim 11 wherein the service control manager adds a security identifier for the services of the service host to the security context.

13. The method of claim 10 wherein each service provides the security context with the aggregation of privileges when accessing an object.

14. The method of claim 10 wherein when the privileges of a service are not available, then the determined privileges are default privileges.

15. A method in a computer system for controlling access of services to objects, the method comprising:
under control of a service control manager, creating a restricted access token that includes the security identifiers of the services as restricted security identifiers; and
under control of a service, providing the restricted access token to establish access rights of the service to an object that has an access control list that includes the security identifier of the service.

16. The method of claim 15 including allowing access to an object only when the service has both non-restricted access and restricted access to the object.

17. The method of claim 15 wherein the security identifiers are created based on service name.

18. The method of claim 15 wherein the creating of the restricted access token includes creating the security identifiers of the services.

19. The method of claim 18 wherein the creating of the restricted access token includes adjusting privileges of the access token to be an aggregation of the privileges of the services.

20. The method of claim 15 wherein the creating of the restricted access token includes adjusting privileges of the access token to be an aggregation of the privileges of the services.
